(19) United States
(12) Patent Application Publication
(10) Pub. No.: US 2007/0216618 A1
(43) Pub. Date: Sep. 20, 2007

(54) Display device

(75) Inventors: Chul-Ho Kim, Yongin-si (KR); Il-Gon Kim, Seoul (KR); Seong-Il Park, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/516,329

(22) Filed: Sep. 6, 2006

(30) Foreign Application Priority Data
Mar. 14, 2006 (KR) 10-2006-0023486

(51) Int. Cl. G09G 3/36

(52) U.S. Cl. 345/87

(57) ABSTRACT

A display device includes a display panel area with a plurality of pixels each including a switching element and gate lines and data lines connected to the pixels, a precharge circuit for applying a precharge voltage to the pixels to precharge the pixels, and at least two voltage transmission lines connected to the precharge circuit to transmit the precharge voltage. In this way, it is possible to test whether the data lines are short-circuited as well as if they are disconnected, in the VI test stage of a liquid crystal display of the SOG type, thereby increasing reliability.

### CROSS-REFERENCE TO RELATED APPLICATION

This application claims priority to and the benefit of Korean Patent Application No. 10-2006-0023486 filed in the Korean Intellectual Property Office on Mar. 14, 2006, the entire contents of which are incorporated herein by reference.

### BACKGROUND OF THE INVENTION

(a) Technical Field

The present disclosure relates to a display device.

(b) Discussion of the Related Art

Recently, flat panel displays such as organic light emitting diode (“OLED”) displays, plasma display panels (“PDPs”), and liquid crystal displays (“LCDs”) have been developed, and they are replacing previous displays employing heavy and large cathode ray tubes (“CRTs”).

PDPs are devices that display characters or images using plasma generated by gas-discharge, and OLED displays are devices that display characters or images by applying an electric field to specific light-emitting organic or high molecule materials. LCDs display images by applying an electric field to a liquid crystal layer disposed between two panels and regulating the strength of the electric field to adjust the transmittance of light passing through the liquid crystal layer.

Among the flat panel displays, as examples, the LCD and the OLED display each include: a display panel provided with pixels including switching elements and display signal lines; a gate driving IC for outputting a gate signal to a gate line among the display signal lines to turn on/off the switching elements of the pixels; a gray voltage generator for generating a plurality of gray voltages; a data driving IC for selecting a voltage corresponding to image data as a data voltage among the gray voltages to apply the data voltage to a data line among the display signal lines; and a signal controller for controlling the above-described elements.

When the display signal lines become disconnected or short-circuited, or the pixels become defective in the process of manufacturing the display device, the disconnection and short-circuiting thereof and the defective pixels can be detected via predetermined tests. Such tests include an array test, a visual inspection (VI) test, a gross test, a module test, and so on.

The signal controller and the gray voltage generator are provided on a printed circuit board (PCB) located outside the array panel. The driving ICs are mounted on a flexible printed circuit (FPC) substrate located between the PCB and the array panel. Typically, there are two PCBs, being arranged at the upper side and left side of the array panel, respectively. The left one is called a gate PCB, and the upper one is called a data PCB. The gate driving IC and the data driving IC are located between the gate PCB and the array panel and between the data PCB and the array panel, respectively, each receiving a signal from the corresponding PCB.

Alternatively, the gate driving IC and the data driving IC may be mounted directly on the array panel without using the gate PCB and the data PCB in a COG (chip on glass) technique, or most circuits including a signal controller, a power generating circuit, etc., along with the gate and data driving ICs, may be mounted on the array panel in an SOG (system on glass) technique.

In a display device formed by the SOG technique, however, nearly all the circuits are mounted on the array panel, so it is not easy to apply a signal for testing due to the complexity of the driving signal and the like. Due to this, it is not easy to discriminate defects, such as disconnection or short-circuiting of the data line in the VI test stage, which is an intermediate stage.

Accordingly, embodiments of the present invention have been made in an effort to provide a display device in which it is easy to discriminate defects of data lines in a VI test.

The above information disclosed in this Background section is only for enhancement of understanding of the background of the invention and therefore it may contain information that does not form the prior art that is already known in this country to a person of ordinary skill in the art.

### SUMMARY OF THE INVENTION

In accordance with an exemplary embodiment of the present invention, there is provided a display device, including a display panel area including a plurality of pixels each having a switching element and gate lines and data lines connected to the pixels, a precharge circuit for applying a precharge voltage to the pixels to precharge the pixels, and at least two voltage transmission lines connected to the precharge circuit to transmit the precharge voltage.

The precharge circuit may include transmission gates connected to the data lines, respectively. At least two adjacent transmission gates of the transmission gates may be connected to different voltage transmission lines.

The display device may further include test pads for applying a test signal to the voltage transmission lines, respectively. The amplitudes of the test signals may be different from each other.

The precharge circuit and the signal controller may be mounted on the display panel area.

The voltage transmission lines may include first to third transmission lines. The precharge circuit may include transmission gates connected to the data lines, respectively.

At least three adjacent transmission gates of the transmission gates may be connected to the first to third transmission lines, respectively.

The display device may further include first to third test pads for applying test signals to the first to third transmission lines, respectively. The amplitudes of the test signals may be different from each other.

The precharge circuit and the signal controller may be mounted on the display panel area.

### BRIEF DESCRIPTION OF THE DRAWINGS

Exemplary embodiments of the present invention will be understood in more detail from the following descriptions taken in conjunction with the following drawings.

FIG. 1 is a block diagram of a liquid crystal display device according to an exemplary embodiment of the present invention.

FIG. 2 is an equivalent circuit diagram of a pixel of a liquid crystal display device according to an exemplary embodiment of the present invention.

FIG. 3 is a schematic layout view of a liquid crystal display device according to an exemplary embodiment of the present invention.

FIG. 4 is a view showing a precharge circuit and wires connected thereto in the liquid crystal display device shown in FIG. 3.

FIG. 5 is a block diagram of the precharge circuit shown in FIG. 4.

### DETAILED DESCRIPTION OF EXEMPLARY EMBODIMENTS

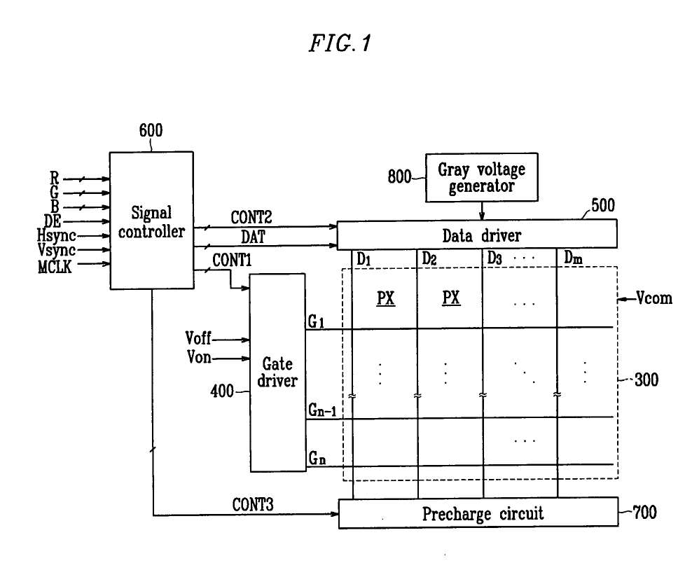

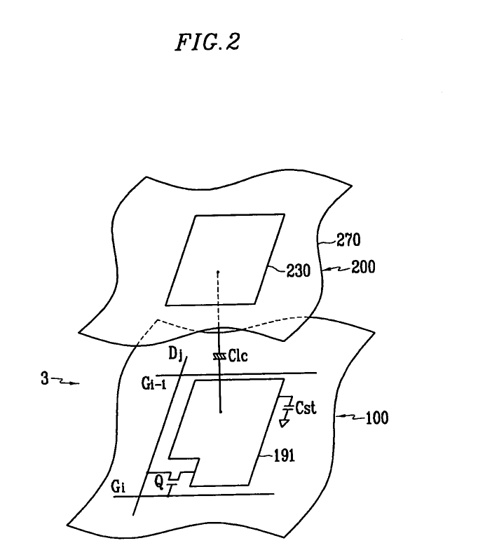

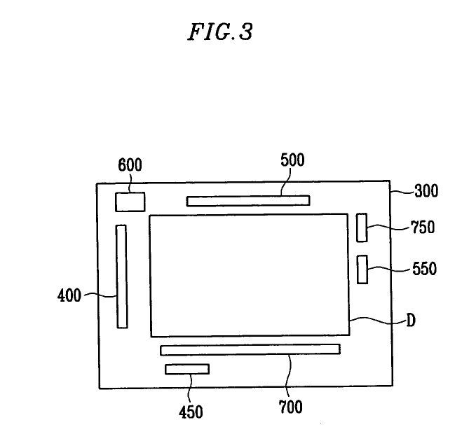

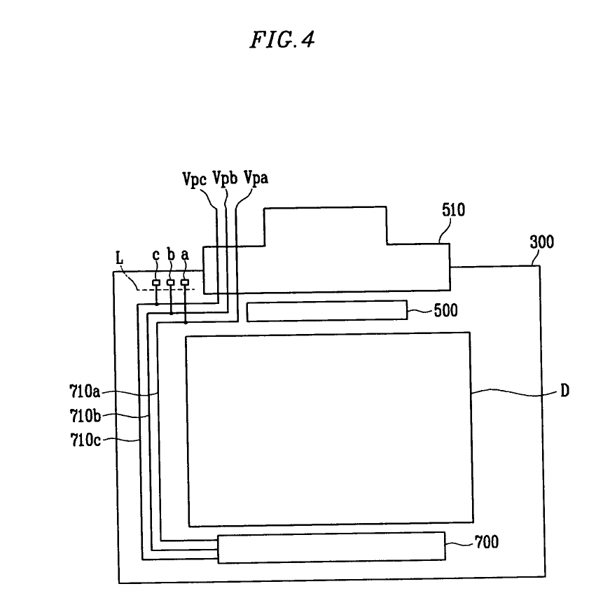

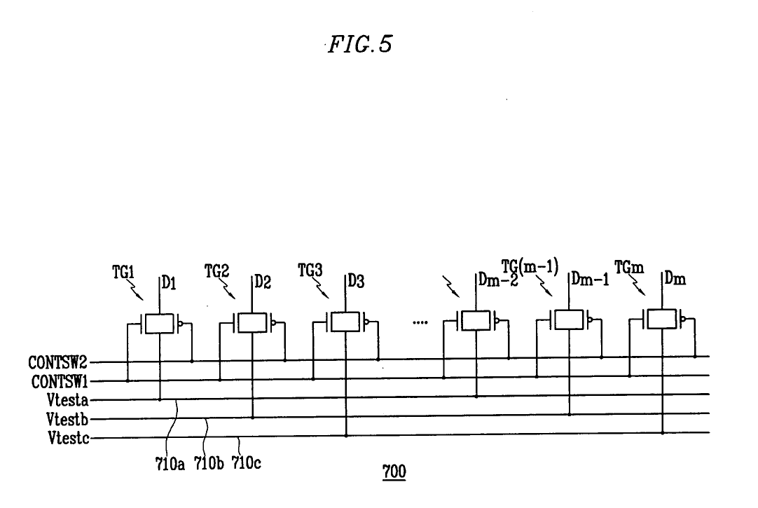

FIG. 1 is a block diagram of a liquid crystal display device according to an exemplary embodiment of the present invention. FIG. 2 is an equivalent circuit diagram of a pixel of a liquid crystal display device according to an exemplary embodiment of the present invention. FIG. 3 is a schematic layout view of a liquid crystal display device according to an exemplary embodiment of the present invention, FIG. 4 is a view showing a precharge circuit and wires connected thereto in the liquid crystal display device shown in FIG. 3, and FIG. 5 is a block diagram of the precharge circuit shown in FIG. 4.

Referring to FIG. 1, a liquid crystal display device according to an exemplary embodiment of the present invention includes a liquid crystal panel assembly 300, a gate driver 400 and a data driver 500 with a precharge circuit 700 connected thereto, a gray voltage generator 800 connected to the data driver 500, and a signal controller 600 that controls the above-described elements.

The liquid crystal panel assembly 300, includes a plurality of display signal lines (G₁-Gₙ, D₁-Dₘ), and a plurality of pixels PX connected to the display signal lines (G₁-Gₙ, D₁-Dₘ) arranged substantially in a matrix structure. More specifically, in the structure as shown in FIG. 2, the liquid crystal panel assembly 300 includes lower and upper panels 100 and 200 facing each other with a liquid crystal layer 3 disposed therebetween.

As shown in FIG. 1, the display signal lines (G₁-Gₙ, D₁-Dₘ) include gate lines (G₁-Gₙ) that transmit gate signals (called scanning signals) and data lines (D₁-Dₘ) that transmit data signals. The gate lines (G₁-Gₙ) extend substantially in a row direction and are substantially parallel to each other, while the data lines (D₁-Dₘ) extend substantially in a column direction and are substantially parallel to each other.

As show in FIG. 2, each pixel PX, for example a pixel PX connected to the i-th (i=1, 2, . . . , n) gate line (Gᵢ) and the j-th(j=1, 2, . . . , m) data line (Dⱼ), includes a switching element Q connected to the signal lines (Gᵢ Dⱼ), a liquid crystal capacitor Clc connected thereto, and a storage capacitor Cst. The storage capacitor Cst may be omitted as necessary.

The switching element Q is provided on the lower panel 100 and is a three terminal element such as a thin film transistor. It has a control terminal connected to the gate line (Gᵢ), an input terminal connected to one of the data lines (Dⱼ), and an output terminal connected to the liquid crystal capacitor Clc and the storage capacitor Cst.

The liquid crystal capacitor Clc includes a pixel electrode 191 on the lower panel 100, a common electrode 270 on the upper panel 200, and the liquid crystal layer 3 as a dielectric between the pixel and common electrodes 191 and 270. The pixel electrode 190 is connected to the switching element Q and the common electrode 270 covers the entire surface of the upper panel 200 and is supplied with a common voltage Vcom. Alternatively, the common electrode 270 may be provided on the lower panel 100. At least one of the two electrodes 191 and 270 may have a shape of a bar or a stripe.

The storage capacitor Cst is an auxiliary capacitor for the liquid crystal capacitor Clc. The storage capacitor Cst includes the pixel electrode 191 and a separate signal line (not shown), which is provided on the lower panel 100 and overlaps the pixel electrode 191 with an insulator disposed between the pixel electrode 191 and the separate signal line. The storage capacitor Cst is supplied with a predetermined voltage such as the common voltage Vcom. Alternatively, the storage capacitor Cst includes the pixel electrode 191 and a previous gate line, which overlaps the pixel electrode 191 with an insulator disposed between the pixel electrode 191 and the previous gate line.

For a color display, each pixel uniquely represents one of the primary colors (spatial division), or sequentially represents the primary colors in time (temporal division), thereby obtaining a desired color as the spatial or temporal sum of the primary colors. The primary colors include three primary colors such as red, green, and blue. FIG. 2 shows an example of the spatial division in which each pixel PX includes a color filter 230 representing one of the three primary colors in an area of the upper panel 200 facing the pixel electrode 191. Alternatively, the color filter 230 is provided on or under the pixel electrode 191 on the lower panel 100.

The pair of polarizers (not shown) for polarizing light are attached on outer surfaces of the liquid crystal panel assembly 300.

A gray voltage generator 800 generates two sets of gray voltages (or reference gray voltages) related to transmittance of the pixels PX. The gray voltages in one set have a positive value with respect to the common voltage Vcom, while the gray voltages in the other set have a negative value with respect to the common voltage Vcom.

The gate driver 400 is connected to the gate lines (G₁-Gₙ) of the liquid crystal panel assembly 300, and applies gate signals, each of which is a combination of the gate-on voltage Von and the gate-off voltage Voff, to the gate lines (G₁-Gₙ).

The data driver 500 is connected to the data lines (D₁-Dₘ) of the liquid crystal panel assembly 300. It selects gray voltages supplied from the gray voltage generator 800 and applies them as data signals to the data lines (D₁-Dₘ). In the case where the gray voltage generator 800 does not supply all the voltages for all the gray levels but rather supplies a predetermined number of reference gray voltages, however, the data driver 500 divides the reference gray voltages to generate gray voltages for all gray levels, and selects data signals from among them.

As shown in FIG. 3, a DC/DC converter 750 and level shifters 450 and 550 form a power generation circuit, and amplify or lower a given voltage to supply the voltage required for driving. The DC/DC converter 750 increases or reduces an external voltage to a given level, and the level shifters 450 and 550 are supplied with voltages from the DC/DC converter 750 and in turn supply the voltages required for the gate driver 400 and the data driver 500, respectively.

The precharge circuit 700 applies a constant voltage to charge the pixels before a data voltage from the data driver 500 is applied, thereby reducing the overall charging time.

The signal controller 600 controls the gate driver 400, the data driver 500, and the precharge circuit 700.

Most parts of this driving apparatus are, as shown in FIG. 3, mounted on the liquid crystal panel assembly 300 (SOG technique). Examples thereof include the gate driver 400, the data driver 500, the signal controller 600, the precharge circuit 700, the level shifter 450 and 550, and the DC/DC converter 750.

More specifically, as shown in FIG. 4, the precharge circuit 700 receives precharge voltages (Vpa, Vpb, and Vpc) through transmission lines 710a, 710b, and 710c.

The precharge voltages (Vpa, Vpb, Vpc) may be generated from a circuit (not shown) located on a printed circuit board (PCB) (not shown) and connected to a flexible printed circuit film 510.

Test pads (a, b, and c) for applying test signals are connected to wires 710a, 710b, and 710c, respectively.

The precharge circuit 700 includes, as shown in FIG. 5, a plurality of transmission gates (TG1-TGm) connected to the data lines (D₁-Dₘ).

As is well known, each of the transmission gates (TG1-TGm) is constituted by two different kinds of transistors, for example, an N-type transistor and a P-type transistor. Input terminals of the transmission gates (TG1-TGm) receive one of the precharge voltages (Vpa, Vpc, Vpc), two control terminals thereof receive switching control signals (CONTSW1, CONTSW2), respectively, and output terminals thereof are connected to the data lines (D1-Dm).

The input terminals of the transmission gates (TG1-TGm) are sequentially connected three at a time to the voltage transmission lines 710a, 710b, and 710c. That is, the input terminals of three adjacent transmission gates (TG1-TGm) are connected to different voltage transmission lines (710a, 710b, and 710c), respectively. For instance, the transmission gates (TG1, TG2, and TG3) are connected to wires 710a, 710b, and 710c, respectively, to receive precharge voltages (Vpa, Vpb, and Vpc).

Meanwhile, in the test stage, test voltages (Vtesta, Vtestb, and Vtestc) may be applied. These test voltages (Vtesta, Vtestb, and Vtestc) are applied through the above-described test pads Ta, Th, and Tc. Each of the test pads Ta, Th, and Tc is cut along a line (L) shown in FIG. 4 using laser trimming after the test, to thus be separated from the voltage transmission lines (710a, 710b, and 710c).

At this time, if the amplitude of the voltages (Vtesta, Vtestb, and Vtestc) to be applied is varied, it is possible to test whether adjacent data lines (D₁-Dₘ) are short-circuited, as well as whether the data lines (D₁-Dₘ) are disconnected.

Now, the operation of the liquid crystal display device will be described in detail.

As shown in FIG. 2, the signal controller 600 is supplied with input image signals R, G, and B and input control signals for controlling the display of the image signals R, G, and B from an external graphics controller (not shown). The input control signals include, for example, a vertical synchronization signal Vsync, a horizontal synchronization signal Hsync, a main clock signal MCLK, and a data enable signal DE.

The signal controller 600 processes the input image signals R, G, and B to be suitable for the operation of the liquid crystal panel assembly 300 in response to the input image signals R, G, and B and the input control signals, and generates gate control signals CONT1, data control signals CONT2, and switching control signals CONT3. Thereafter, the signal controller 600 provides the gate control signals CONT1 to the gate driver 400, the data control signals CONT2 and the processed image signals DAT to the data driver 500, and the switching control signals CONT3 to the precharge circuit 700.

The gate control signals CONT1 include a scanning start signal for instructing a start of scanning and at least one clock signal for controlling an output time of the gate-on voltage Von. The gate control signals CONT1 may further include an output enable signal for defining a duration of the gate-on voltage Von.

The data control signals CONT2 include a horizontal synchronization start signal for informing of a start of transmission of image data for a row of pixels PX, a load signal for instructing to apply data signals to the data lines (D1-Dm), and a data clock signal. The data control signals CONT2 may further include an inversion signal for reversing the polarity of the voltages of the data signals with respect to the common voltage Vcom, hereinafter, “the polarity of the voltages of the data signals with respect to the common voltage” is abbreviated to “the polarity of the data signals.

The switching control signals CONT3 includes a plurality of signals having opposite phases.

The precharge circuit 700 applies a constant voltage to the data lines (D₁-Dₘ) to precharge the pixels in response to the switching control signals CONT3 from the signal controller 600.

In response to the data control signals CONT2 from the signal controller 600, the data driver 500 receives the digital image signals DAT for a row of pixels PX from the signal controller 600, converts the digital image signals DAT into the analogue data signals by selecting the gray voltages corresponding to the digital image signals DAT, and applies the converted analog data signals to the corresponding data lines (D1-Dm).

In response to the gate control signals CONT1 from the signal controller 600, the gate driver 400 applies the gate-on voltage Von to the gate lines (G₁-Gₙ), thereby turning on the switching elements Q connected to the gate lines (G₁-Gₙ). Then, the data signals applied to the data lines (D₁-Dₘ) in turn are supplied to corresponding pixels via the turned-on switching elements Q.

The difference between the voltage of the data signal and the common voltage Vcom applied to a pixel is expressed as a charged voltage of the liquid crystal capacitor Clc, that is, a pixel voltage. The liquid crystal molecules have orientations depending on a magnitude of the pixel voltage, and the orientations determine polarization of light passing through the liquid crystal layer 3. The polarizers attached to the display panel assembly 300 convert light polarization into light transmittance.

By repeating the above-described procedure for each one horizontal period, which is also referred to as “1H”, and equals a period of a horizontal synchronization signal Hsync and of a data enable signal DE, all gate lines (G₁-Gₙ) are sequentially supplied with the gate-on voltage Von, thereby applying the data voltages to all pixels to display the images of one frame.

When the next frame starts after finishing one frame, the inversion signal applied to the data driver 500 is controlled such that a polarity of the data signals applied to each pixel PX is reversed from a polarity of the previous frame (“frame inversion”). The inversion signal may be controlled such that the polarity of the data signals flowing in a data line in one frame is reversed, for example, “row inversion”, “dot inversion” according to the characteristics of the inversion signal, or the polarity of the data voltages in one pixel row is reversed, for example, “column inversion”, “dot inversion”.

As described above, there are provided three wires connected to the input terminals of the transmission gates (TG1-TGm) of the precharge circuit 700 so that it can be tested whether the data lines (D₁-Dₘ) are short-circuited, as well as whether they are disconnected.

Although the exemplary embodiments of the present invention have been described with respect to the provision of three wires, two such wires also may be provided.

In this way, it is possible to test whether the data lines are short-circuited, as well as whether they are disconnected, in the VI test stage of a liquid crystal display of the SOG type, thereby increasing reliability.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device, comprising:
a display panel area including a plurality of pixels each comprising a switching element and a plurality of gate lines and plurality of data lines connected respectively to the plurality of pixels;
a precharge circuit for applying a precharge voltage to the plurality of pixels to precharge the plurality of pixels; and
at least two voltage transmission lines connected to the precharge circuit to transmit the precharge voltage to the plurality of pixels.

2. The display device of claim 1, wherein the precharge circuit comprises a plurality of transmission gates connected to the plurality of data lines, respectively.

3. The display device of claim 2, wherein at least two adjacent transmission gates of the plurality of transmission gates are connected to different ones of the at least two voltage transmission lines.

4. The display device of claim 3, further comprising test pads for applying test signals to the at least two voltage transmission lines, respectively.

5. The display device of claim 4, wherein amplitudes of the test signals are different from each other.

6. The display device of claim 5, wherein the precharge circuit and the signal controller are mounted on the display panel area.

7. The display device of claim 1, wherein the at least two voltage transmission lines comprise first, second, and third transmission lines.

8. The display device of claim 7, wherein the precharge circuit comprises a plurality of transmission gates connected to the plurality of data lines, respectively.

9. The display device of claim 8, wherein three adjacent transmission gates of the plurality of transmission gates are connected to the first, second, and third transmission lines, respectively.

10. The display device of claim 9, further comprising first, second, and third test pads for applying test signals to the first, second, and third transmission lines, respectively.

11. The display device of claim 10, wherein amplitudes of the test signals are different from each other.

12. The display device of claim 11, wherein the precharge circuit and the signal controller are mounted on the display panel area.
